(19) United States
(12) Patent Application Publication
(10) Pub. No.: US 2003/0065923 A1
(43) Pub. Date: Apr. 3, 2003

(54) Systems and methods for converting physical signatures to electronic signatures

(76) Inventor: Travis J. Parry, Boise, ID (US)

Correspondence Address: HEWLETT-PACKARD COMPANY, Intellectual Property Adminisitration, P.O. Box 272400, Fort Collins, CO, 80527-2400, US

(21) Appl. No.: 09/967,051

(22) Filed: Sep. 28, 2001

(51) Int. Cl. H04L 9/00

(52) U.S. Cl. 713/176

(57) ABSTRACT

Systems and methods for converting physical signatures to electronic signatures are described that utilize public keys encoded in ink strands embedded or suspended in a printing material that is used to create the physical signature. A user signs a paper document with the signed ink and the paper document is scanned to create an electronic document. A public key associated with the user is identified in the ink strands in the physical signature. An electronic signature database is accessed to obtain an electronic signature that is uniquely associated with the public key detected in the ink strands. The electronic signature is retrieved and attached to the electronic document to create an electronically signed electronic document.

### TECHNICAL FIELD

This invention generally relates to electronic signatures and, more particularly, to converting physical signatures to electronic signatures.

### BACKGROUND

As enterprises move from paper-based systems to more economical paperless environments, new barriers are presented that must be overcome with new technology. Business transactions, agreements and authorizations are some examples of events that require one or more person's assent, evidenced by that person's signature, that must be electronically perpetuated in a paperless system. Perpetuation is required to maintain the commercial quality of permanence that is required to support audit, evidentiary and enforcement requirements.

In October 2000, the federal Electronic Signatures in Global and National Commerce Act (also known as “E-Sign”) was enacted. The new law broadly authorizes electronic records and electronic signatures as being legally effective. The existence of this new law makes business transactions conducted electronically easier to enforce. Therefore, a major barrier for conducting electronic business transactions has been removed, and greater proliferation of electronic business transactions will no doubt be seen in the marketplace.

Typically, electronic signatures are applied to electronic documents within a user's computer. After the electronic signature is appended to an electronic document, the electronic document is electronically transmitted to another computer, where the electronic document may be processed further or stored.

While many solutions have been found to store and process electronic documents with electronic signatures, problems still exist because many business transactions, although conducted electronically, still require a user to physically affix a user signature to a paper document. Translating a physical signature into an electronic signature and incorporating uniquely identifying features into the physical signature so it can be used to verify documents presents new problems to overcome.

### SUMMARY

Systems and methods are described herein for converting physical signatures to electronic signatures. An electronic signature authority keeps an electronic signature database in which user identifiers, public keys and electronic signatures are associated with one another. Ink strands suspended in ink used in a physical signature are used to encode a public key that is recognized with the physical signature is scanned.

When the electronic signature authority issues a user identifier to a user, the user provides information from which a public key associated with the user is derived. The electronic signature authority creates an electronic signature, which is associated with the user and is stored in the electronic signature database and is associated with the user. The user is issued special pens that contain signed ink that is embedded with ink strands that identify the public key assigned to the user.

When a user wishes to create an electronically signed document, the user physically signs a document with the signed ink. The document is scanned by a second or third party to the transaction to convert the document into an electronic document. The public key is identified in the ink strands, then the electronic signature authority is contacted and the electronic signature database is searched to find a match with the public key.

When the public key is found in the electronic signature database, the electronic signature associated with the public key is retrieved from the database and is affixed to the electronic document. Thus, a physical document with a physical signature is converted into an electronic document with an electronic signature.

The described systems and methods may also be used to affix an electronic signature to an electronic document by having a user sign a physical signature that is associated with an electronic document.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1a-1d are illustrations of a physical signature created with ink having ink strands suspended there.

FIG. 2 is a block diagram illustrating systems and processes for converting physical signatures to electronic signatures.

FIG. 3 is a flow diagram depicting a method for establishing a user account with an electronic signature authority.

FIG. 4 is a flow diagram depicting a method for converting a physical signature into an electronic signature.

### DETAILED DESCRIPTION

The following description sets forth one or more specific implementations and/or embodiments of systems and methods for converting physical signatures to electronic signatures. The systems and methods incorporate elements recited in the appended claims. These implementations are described with specificity in order to meet statutory written description, enablement, and best-mode requirements. However, the description itself is not intended to limit the scope of this patent.

Also described herein are one or more exemplary implementations of systems and methods for converting physical signatures into electronic signatures. Applicant intends these exemplary implementations to be examples only. Applicant does not intend these exemplary implementations to limit the scope of the claimed present invention(s). Rather, Applicant has contemplated that the claimed present invention(s) might also be embodied and implemented in other ways, in conjunction with other present or future technologies.

Computer-Executable Instructions

An implementation of systems and methods for converting physical signatures to electronic signatures may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Computer-Readable Media

An implementation of systems and methods for converting physical signatures into electronic signatures may be stored on or transmitted across some form of computer-readable media. Computer-readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communications media” typically embodies computer-readable instructions, data structures, program modules, or other data in a modulated data signal, such as carrier wave or other transport mechanism. Communication media also includes any information delivery media.

Exemplary Physical Signature Using Signed Ink

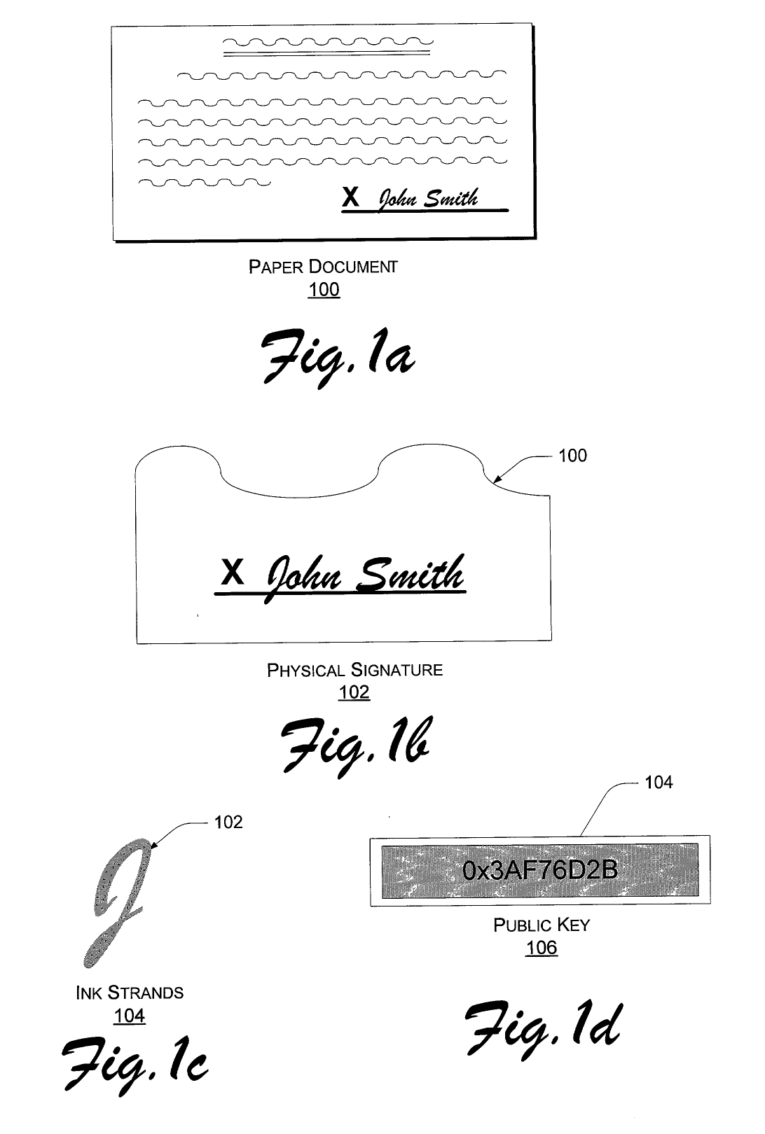

FIGS. 1a is an illustration of a paper document 100 that includes a physical signature 102 (FIG. 1b). FIG. 1c is an enlarged view of the physical signature 102, showing ink strands 104 that are embedded in the physical signature 102. The ink strands 104 are small particles of matter that are suspended in writing ink (not shown) to create signed ink, which is used to write the physical signature. The ink strands 104 may be microscopic in nature. However, the size of the ink strands 104 depends on the ability to integrate the ink strands 104 with writing ink so that the writing ink may be used in typical fashion. Also, the manner in which the ink strands 104 will be detected (discussed below) dictates the size that the ink strands are required to be.

In one implementation, the ink strands 104 are composes of one or more stands of deoxyribonucleic acid (DNA) that are configured to code a public key that is related to a signature of a user authorized to create a physical signature with the signed ink. FIG. 1d is an illustration of an ink strand 104 that contains a public key 106. It is noted that FIG. 1d is a simplified diagram that shows the public key 106 in hexadecimal form. However, it is noted that the actual public key 106 may not contain actual digits, but will contain certain configurations that denote the digits contained in the public key 106.

Exemplary Operational Environment for Converting Physical Signatures to Electronic Signatures

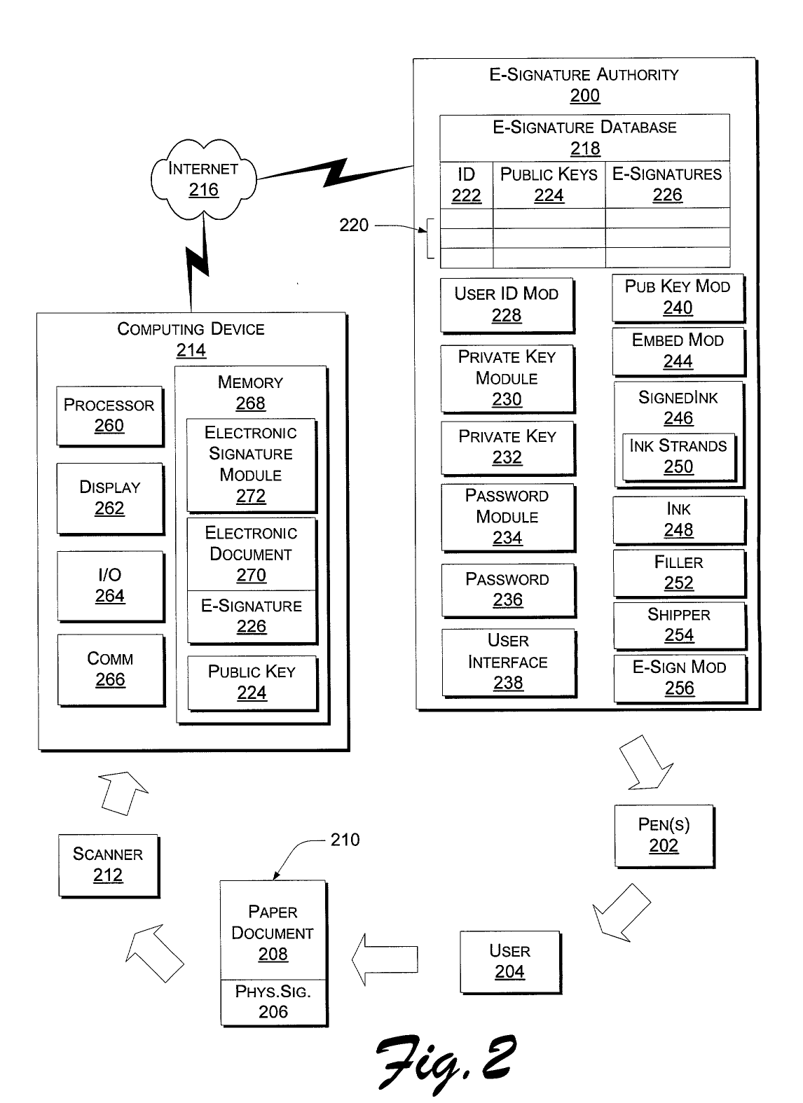

FIG. 2 is a block diagram illustrating an exemplary operational environment for converting physical signatures to electronic signatures. Briefly, the exemplary operational environment includes an electronic signature authority 200 that creates and issues special pens 202 to subscribing users 204. A user 204 uses a special pen 202 to affix the user's physical signature 206 to a paper document 208, thereby creating a physically signed document 210. In an alternative implementation, specialized ink cartridges (not shown) may be manufactured and distributed instead of complete pens.

The user, a party with whom the document 208 is being executed or a third party (not shown) utilizes a scanner 212 to scan the paper document 208. A computing device 214 utilizes the scanner 212 results to access the electronic signature authority 200, for example, via the Internet 216, to obtain an electronic signature that is uniquely associated with the physical signature 206.

In greater detail, the electronic signature authority (ESA) 200 includes an electronic signature database 218 that includes a plurality of records 220. Each record 220 includes a user identifier 222, a public key 224 associated with the user identifier 222, and an electronic signature 226 associated with the user identifier 222.

A user identifier module 228 issues a user identifier 222 to a user 204. The user identifier 222 may be a typical digital id that is issued in known electronic signature schemes. A private key module 230 issues a private key 232 to the user 204. A password module 234 is configured to provide a user interface 238 to the user 204 so that the user 204 may provide a private password 236 to the ESA 200. A public key module 240 creates the public key 224 using the private key 232 and the password 236, e.g., by encrypting the private key 232 with the password 236.

An embedding module 244 creates signed ink 246 from printing ink 248 by embedding, or suspending, ink strands 250 into the ink 248. The printing ink 248 is simply a printing material that does not contain ink strands. The public key 224 is encoded within each of the ink strands 250. A filler 252 inserts the signed ink 246 into one or more pens 202 and/or ink cartridges (not shown) and a shipper 254 ships the pen(s)/ink cartridges to the user 204. The pen 202 may be in the form of a ballpoint pen, wherein a nib at the end of the pen 202 is formed by a ball firmly secured by the pen 202. When the ball is rotated by a normal writing motion, the signed ink 246 is transferred from the pen 202 to the paper document 208. If ink cartridges are used instead of pens, then a user may insert an ink cartridge into a personal pen preferred by the user.

In an alternative embodiment, the paper document 208 may not be required. The paper document 208 may already be in electronic form as an electronic document 270. In this case, a user 204 might affix a physical signature to some medium that can subsequently be scanned. After the electronic signature 226 is obtained, it is appended to the electronic document 270.

An electronic signature module 256 is configured to handle requests from the computing device 214 for information related to the public key 224, the user identifier 222 and/or the electronic signature 226. Any hardware or software that may be required to communicate with the Internet 216 to provide this information may be included in the electronic signature module 256.

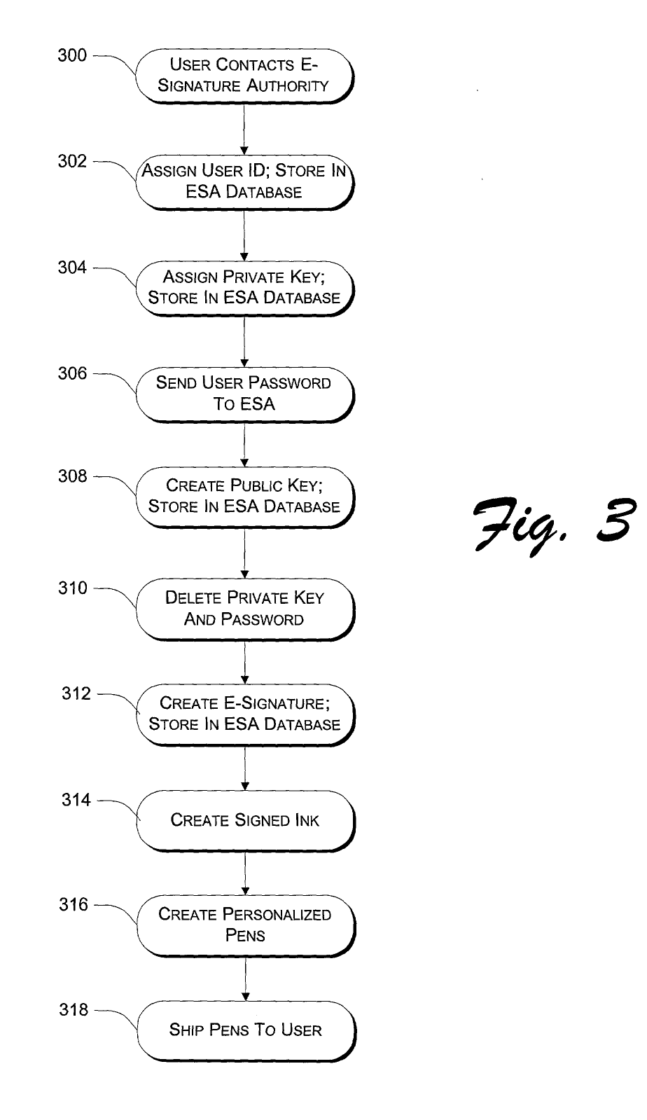

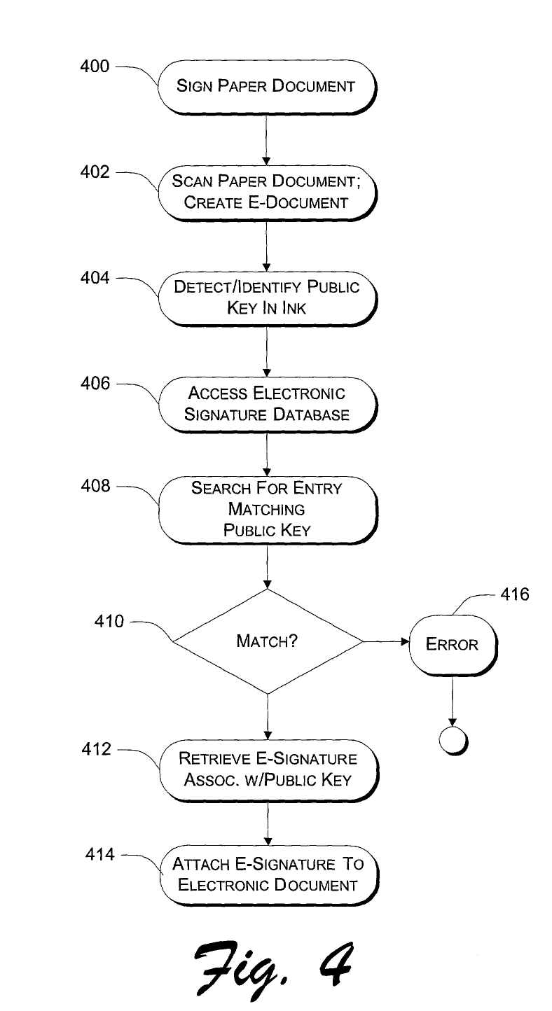

The computing device 214 may be a typical personal computer and contains a processor 260, a display 262, an input/output (I/O) module 264 and a communications module 266 that handles network communications. The computing device 214 also includes memory 268 that stores the public key 224 once the public key 224 has been created and returned from the ESA 200. The memory 268, at times, also stores the electronic document 270 and the electronic signature 226. An electronic signature module 272 handles the processing required between the scanner 212, the computing device 214 and the electronic signature authority 200. The features shown and the functions described in FIG. 2 will be described in greater detail, below, with respect to FIG. 3 and FIG. 4. Continuing reference will be made to the elements and reference numerals included in FIG. 2.

Methodological Implementation of Establishing a User with an Electronic Signature Authority

FIG. 3 is a flow diagram depicting a method for establishing a user with an electronic signature authority. For purposes of discussing FIG. 3, continuing reference will be made to the elements and reference numerals shown in FIG. 2.

At block 300, the user 204 contacts the electronic signature authority 200 to subscribe to electronic signature services offered by the electronic signature authority 200. The ESA 200 initially assigns the user identifier 222 to the user 204 after the user 204 has provided some initial registration information (block 302). The ESA 200 provides the user identifier 222 to the computing device 214 and stores the user identifier 222 in the electronic signature database 218. The user identifier 222 is a digital id similar to those assigned in electronic signature schemes known in the art. The private key 232 is created by the ESA 200 at block 304 and is stored in the computing device 214 and the electronic signature database 218.

At block 306, the password module 234 requests—via the user interface 238—a private password 236 from the user 204. The public key module 240 creates the public key 224 by encrypting the private key 232 with the password 236 provided by the user 204 (block 308). The public key 224 is stored in the electronic signature database 218 and is associated with the user identifier 222 assigned to the user. Once the public key 224 has been created, the electronic signature authority 200 deletes the private key 232 and the password 236 from the ESA 200 (block 310) so that the only copies of the private key 232 and the password 236 are stored with the user 204.

At block 312, the electronic signature 226 is created and stored in the electronic signature database 218. Typically, an electronic signature 226 contains the user identifier 222 and the public key 224. If the electronic signature 226 includes the public key 224, then the electronic signature 226 is created after the public key 224 is created.

The signed ink 246 is created by the electronic signature authority 200 according to one of several methods known in the art (block 314). The signed ink 246 may include microscopic or small macroscopic particles on which the public key 224 is coded. The public key 224 may be printed on each ink strand 250, or the ink strands 250 may be arranged in a configuration that identifies a code that can be decoded to reveal the public key 224. Such work has been accomplished with strands of DNA (deoxyribonucleic acid) and that may be incorporated into the technique described herein.

At block 316, the pens 202 are filled with the signed ink 246 by the filler 252 and are shipped to the user 204 by the shipper 254 at block 318. The pens 202 are highly personalized, since any signature created with the signed ink 246 in the pens 202 will be identified as the physical signature of the user 204 to whom the pens 202 were registered. Therefore, strict security—akin to the security required when issuing credit cards—must be utilized to ensure that only the authorized user 204 only receives the pens 202.

Methodological Implementation of Converting a Physical Signature to an Electronic Signature

FIG. 4 is a flow diagram depicting a method for converting a physical signature to an electronic signature. For purposes of discussing FIG. 4, continuing reference will be made to the elements and reference numerals shown in FIG. 2.

At block 400, the user 204 signs the paper document 208 with a pen 202 that contains the signed ink 246. The user 204 or another party (not shown) utilizes the scanner 212 or other known method to convert the physical document 210 into the electronic document 270. The scanner 212 is also configured to detect the presence of the ink strands 250 in the signed ink 246 (block 402). At block 404, the scanner 212 or some other specialized instrument (not shown) may be used to detect and/or identify the public key 224 identified by the ink strands 250 in the signed ink 246.

Once the computing device 214 has obtained the public key 224, then the electronic signature module 272 accesses the electronic signature database (block 406) 218 and searches for an entry that matches the public key 224 (block 408). If no matching entry is found (“No” branch, block 410), then the process returns an error and terminates (block 416). If a matching entry is found (“Yes” branch, block 410), then the electronic signature 226 that is associated with the public key 224 is retrieved at block 412 and the electronic signature 226 is attached to the electronic document 270 (block 414). Thus, the electronic document 270 with the electronic signature 226 is created from the paper document 208 and the physical signature 206.

Conclusion

Implementation of the systems and methods described herein provide a secure and convenient way to convert a physical signature into an electronic signature that uniquely identifies a signer of an electronic or paper document. In turn, attaching the electronic signature to the document provides a reliable method for verifying the accuracy and authenticity of the electronic document.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method, comprising:
encoding a public key in one or more ink strands;
embedding the one or more ink strands in a printing material; and
wherein the public key is uniquely associated with an electronic signature that is unique to a user.

2. The method as recited in claim 1, further comprising deriving the public key from information associated with the user.

3. The method as recited in claim 1, wherein the printing material further comprises ink.

4. The method as recited in claim 1, further comprising:
assigning a private key to the user; and
deriving the public key using the private key.

5. The method as recited in claim 1, further comprising:
receiving a password from the user; and
deriving the public key using the password.

6. The method as recited in claim 1, further comprising placing the printing material including the ink strands into a writing instrument.

7. The method as recited in claim 1, further comprising placing the printing material including the ink into a replaceable cartridge for a writing instrument.

8. The method as recited in claim 1, further comprising distributing the printing material including the ink strands to the user.

9. The method as recited in claim 1, wherein the ink strands further comprise microscopic particles that contain public key data.

10. The method as recited in claim 1, wherein the ink strands further comprise deoxyribonucleic acid (DNA) strands that are arranged in such a way as to denote the public key.

11. One or more computer-readable media containing computer-executable instructions that, when executed on a computer, perform the following steps:
receiving an electronic document that has been converted from a paper document having a physical signature;
detecting one or more ink strands in ink used to create the physical signature;
identifying a public key denoted by one or more of the one or more ink strands;
locating an electronic signature uniquely associated with the public key; and
attaching the electronic signature to the electronic document to create an electronically signed electronic document.

12. The one or more computer-readable media as recited in claim 11, wherein the identifying a public key further comprises reading a public key from one or more of the one or more ink strands, the public key being stored on each of the one or more ink strands.

13. The one or more computer-readable media as recited in claim 11, wherein the identifying a public key further comprises determining the public key from a coded arrangement of a plurality of the one or more ink strands.

14. The one or more computer-readable media as recited in claim 11, wherein the identifying a public key further comprises determining the public key from a unique arrangement of deoxyribonucleic acid (DNA) strands that are included in the one or more ink strands.

15. The one or more computer-readable media as recited in claim 11, wherein the locating an electronic signature further comprises:
accessing an electronic signature database that contains a plurality of electronic signatures and a plurality of public keys, each electronic signature being uniquely associated with one or the plurality of public keys;
finding a public key in the electronic signature database that matches the public key identified by the ink strands; and
if the public key identified in the ink strands if found in the electronic signature database, locating the electronic signature that is uniquely associated with the public key found in the electronic signature database.

16. The one or more computer-readable media as recited in claim 15, further comprising retrieving the located electronic signature from the electronic signature database.

17. A method for converting a physical signature to an electronic signature, comprising:
identifying a public key from one or more ink strands contained in ink in which the physical signature was created;
locating the public key in an electronic signature database;
identifying an electronic signature in the electronic signature database that is uniquely associated with the public key; and
substituting the electronic signature in place of the physical signature.

18. The method as recited in claim 17, wherein the identifying a public key further comprises reading the public key from one or more of the one or more ink strands.

19. The method as recited in claim 17, wherein the identifying a public key further comprises decoding a public key from a specific arrangement of a plurality of the one or more ink strands.

20. The method as recited in claim 17, wherein the locating further comprises accessing an electronic signature authority to access the electronic signature database.

21. The method as recited in claim 17, wherein the substituting further comprises attaching the electronic signature to an electronic document that is an electronic version of a paper document to which the physical signature was affixed.

22. An electronic signature database stored on one or more computer-readable media, comprising:
a plurality of electronic signatures, each electronic signature being uniquely associated with a user;
a plurality of public keys, each public key being uniquely associated with one of the electronic signatures; and
wherein an electronic signature for a particular user can be identified by locating a public key that is associated with the particular user.

23. The electronic signature database as recited in claim 22, wherein each public key in the database is incorporated into ink strands embedded in ink contained in a writing instrument under the exclusive control of the user.

24. A system, comprising:
an electronic signature database for storing a plurality of electronic signatures and a plurality of public keys, each electronic signature being uniquely associated with a user and each public key being uniquely associated with an electronic signature;
a public key module configured to create the public keys from data associated with each user uniquely associated with each public key; and
an embedding module configured to program a public key from the electronic signature database into one or more ink strands.

25. The system as recited in claim 24, wherein the embedding module is further configured to embed the ink strands into ink.

26. The system as recited in claim 24, further comprising:
a user interface configured to accept a password from a user;
a password module configured to prompt the user via the user interface for a password that is private to the user, and to accept a private password from the user; and
wherein the password accepted from the user is used to derive the public key uniquely associated with the user.

27. The system as recited in claim 24, wherein the ink strands are embedded in ink to create signed ink, and further comprising means to securely transfer the signed ink to the user so that the signed ink is under the exclusive control of the user.

28. The system as recited in claim 24, further comprising a private key module configured to assign a unique private key to a user, wherein the private key a user is used at least in part to create the public key assigned to the user.
